(19) United States
(12) Patent Application Publication
(10) Pub. No.: US 2023/0153718 A1
(43) Pub. Date: May 18, 2023

(54) SCHEDULING DEVICE AND METHOD

(71) Applicants: Inventec (Pudong) Technology Corporation, Shanghai (CN); INVENTEC CORPORATION, Taipei City (TW)

(72) Inventors: Yun-Jie JHANG, Taipei City (TW); Guilherme Henrique GALELLI CHRISTMANN, Taipei City (TW); Trista Pei-Chun CHEN, Taipei City (TW); Feng PAN, Taipei City (TW); Shan-Fa SHIH, Taipei City (TW)

(21) Appl. No.: 17/654,996

(22) Filed: Mar. 16, 2022

(30) Foreign Application Priority Data
Nov. 18, 2021 (CN) 202111371566.1

(51) Int. Cl. G06Q 10/06; G06Q 50/04

(52) U.S. Cl. CPC G06Q 10/06314; G06Q 50/04; G06Q 10/06315

(57) ABSTRACT

A scheduling device is provided, which includes a memory and a processor. The processor is configured to execute instructions to perform the following operations: (a) according to an order, are generating multiple candidate multi-production line schedules respectively, and each of the multiple candidate multi-production line schedules is used to assign multiple products of the order to multiple production lines; (b) performing a first crossover processing for each of the multiple candidate multi-production lines; (c) calculating respective first fitness scores of the multiple candidate multi-production line schedules for an elimination processing; (d) performing a second crossover processing for each of the multiple candidate multi-production lines; (e) calculating respective second fitness scores of the multiple candidate multi-production line schedules for an elimination processing; (f) determining whether an recursive end condition has been met according to the multiple second fitness scores.

### CROSS-REFERENCE TO RELATED APPLICATION

This application claims priority to China Application Serial Number 202111371566.1, filed Nov. 18, 2021, which is herein incorporated by reference in its entirety.

### BACKGROUND

### Field of Disclosure

The present disclosure relates to a production technique. More particularly, the present disclosure relates to a scheduling device and method.

### Description of Related Art

Generally, after a factory receives an order, complicated scheduling work is often required to efficiently produce products on the production line in the factory. This often requires a lot of manual work or uses simple programming tables to generate better schedules. However, the above-mentioned scheduling method is much time consuming and much laborious, and the obtained scheduling result from the above-mentioned scheduling method may not necessarily be a better scheduling result. Therefore, how to generate an optimal schedule efficiently and without consuming a lot of resources is a problem that those skilled in the art are eager to solve.

### SUMMARY

The disclosure provides a scheduling device, configured for generating a multi-production line schedule to produce an order, wherein the order comprises a plurality of products and a plurality of demand quantities of the plurality of products, and the multi-production line is configured for scheduling a sequence and quantities of the plurality of products to be produced by a plurality of production lines, wherein the scheduling device comprises a memory and a processor. The memory is configured for storing a plurality of instructions. The processor is connected to the memory, and configured for executing the plurality of instructions to perform the following operations: (a) generating a plurality of candidate multi-production line schedules respectively according to the order, wherein each of the plurality of candidate multi-production line schedules is configured for assigning the plurality of products of the order to the plurality of production lines; (b) for the each of the plurality of candidate multi-production line schedules, randomly concentrating quantities of a first product on two of the plurality of production lines to one of the two of the plurality of production lines; (c) calculating respective first fitness scores of the plurality of candidate multi-production line schedules according to respective efficiencies of the plurality of candidate multi-production line schedules corresponding to the order, and eliminating a part of the plurality of candidate multi-production line schedules according to the plurality of first fitness scores; (d) for the each of the plurality of candidate multi-production line schedules, randomly distributing a quantity of a second product on one of the plurality of production lines to the plurality of production lines; (e) calculating respective second fitness scores of the plurality of candidate multi-production line schedules according to respective efficiencies of the plurality of candidate multi-production line schedules corresponding to the order, and eliminating a part of the plurality of candidate multi-production line schedules according to the plurality of second fitness scores; (f) determining whether a recursive end condition has been met according to the plurality of second fitness scores; (g) selecting the multi-production line schedule from the plurality of candidate multi-production line schedules when the recursive end condition has been met; and (g) selecting the multi-production line schedule from the plurality of candidate multi-production line schedules when the recursive end condition has been met; and (h) performing steps (b) to (f) again when the recursive end condition has not been met.

The disclosure provides a scheduling method, configured for generating a multi-production line schedule to produce an order, wherein the order comprises a plurality of products and a plurality of demand quantities of the plurality of products, and the multi-production line is configured for scheduling a sequence and quantities of the plurality of products to be produced by a plurality of production lines, wherein the scheduling method comprises: (a) generating a plurality of candidate multi-production line schedules respectively according to the order, wherein each of the plurality of candidate multi-production line schedules is configured for assigning the plurality of products of the order to the plurality of production lines; (b) for the each of the plurality of candidate multi-production line schedules, randomly concentrating quantities of a first product on two of the plurality of production lines to one of the two of the plurality of production lines; (c) calculating respective first fitness scores of the plurality of candidate multi-production line schedules according to respective efficiencies of the plurality of candidate multi-production line schedules corresponding to the order, and eliminating a part of the plurality of candidate multi-production line schedules according to the plurality of first fitness scores; (d) for the each of the plurality of candidate multi-production line schedules, randomly distributing a quantity of a second product on one of the plurality of production lines to the plurality of production lines; (e) calculating respective second fitness scores of the plurality of candidate multi-production line schedules according to respective efficiencies of the plurality of candidate multi-production line schedules corresponding to the order, and eliminating a part of the plurality of candidate multi-production line schedules according to the plurality of second fitness scores; (f) determining whether a recursive end condition has been met according to the plurality of second fitness scores; (g) selecting the multi-production line schedule from the plurality of candidate multi-production line schedules when the recursive end condition has been met; and (g) selecting the multi-production line schedule from the plurality of candidate multi-production line schedules when the recursive end condition has been met; and (h) performing steps (b) to (f) again when the recursive end condition has not been met.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a scheduling device of the present disclosure.

FIG. 2 is a flowchart of a scheduling method of the present disclosure.

FIG. 3 is a flowchart of additional steps of the scheduling method in some embodiments according to the present disclosure.

FIG. 4 is a schematic diagram of multiple candidate multi-production line schedules in some embodiments according to the present disclosure.

FIG. 5 is a schematic diagram of concentrated processing of one of the multiple candidate multi-production line schedules in some embodiments according to the present disclosure.

FIG. 6 is a schematic diagram of calculating fitness scores for six candidate multi-production line schedules in some embodiments according to the present disclosure.

FIG. 7 is a flow diagram of updating the six multi-production line schedules in some embodiments according to the present disclosure.

FIG. 8 is a schematic diagram of distributed processing of one of the multiple candidate multi-production line schedules in some embodiments according to the present disclosure.

FIG. 9 is a schematic diagram of mutation processing of one of the multiple candidate multi-production line schedules in some embodiments according to the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

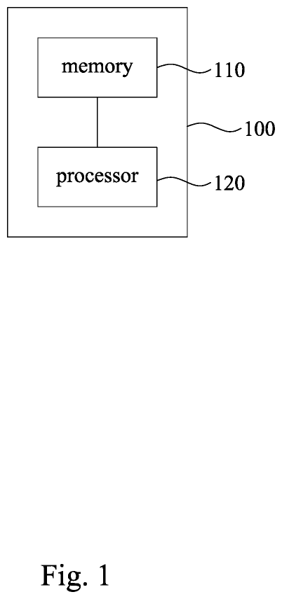

Reference is made to FIG. 1, which is a block diagram of a scheduling device 100 of the present disclosure. The scheduling device 100 includes a memory 110 and a processor 120. The processor 120 is connected to the memory 110.

In some embodiments, the scheduling device 100 is established by a computer, a server or a processing center. In some embodiments, the memory 110 can be implemented using a memory cell, a flash memory, a ROM, a hard disk, or any equivalent storage device. In some embodiments, the processor 120 can be implemented by an integrated circuit unit, a central processing unit, or a computing unit.

In some embodiments, the scheduling device 100 is not limited to include the memory 110 and the processor 120. The scheduling device 100 can further include other components required to operating the scheduling device 100 in various applications. For example, the scheduling device 100 can further include an output interface (e.g., a display panel for displaying information), an input interface (e.g., a touch panel, a keyboard, a microphone, a scanner or a flash memory reader) and a communication circuit (e.g., a WiFi communication module, a Bluetooth communication module, a wireless telecommunication module, etc.).

In this embodiment, the scheduling device 100 is used for generating a multi-production line schedule to produce an order, the order includes multiple products (e.g., wafers) and multiple demand quantities of the multiple products, and the multi-production line is used for scheduling a sequence and quantities of the multiple products to be produced by multiple production lines (e.g., production lines for producing wafers).

In some embodiments, the scheduling device 100 can receive orders to store in the memory 110 from a server, a cloud device, or a distributed storage system for storing various orders. For example, the order can store various product types and demand quantities of the various products according to a format in Table 1 below.

TABLE 1

| Scheduling time | Ship time | Product type | Demand quantity |
|---|---|---|---|
| Jul. 19, 2021 | Jul. 20, 2021 | Product 1 | 30 |
| Jul. 19, 2021 | Jul. 20, 2021 | Product 2 | 100 |
| | . | | |
| | . | | |
| | . | | |
| Jul. 19, 2021 | Jul. 20, 2021 | Product 20 | 50 |

In some embodiments, the scheduling device 100 can further receive production line information from a server, a cloud device or a distributed storage system, etc. which stores various production line information to store in the memory 110, where the production line information can include the multiple production lines and products that can be produced by the multiple production lines. For example, the production line information can store various production lines and the products that can be produced by each production line according to the format of Table 2 below.

TABLE 2

| Production line type | Product types that can be produced |
|---|---|
| Production line 1 | Product 1, product 2 and product 4 |
| Production line 2 | Product 1, product 3 and product 4 |
| . | |
| . | |
| . | |
| Production line 40 | Product 1, product 2, product 3 |
| | and product 4 |

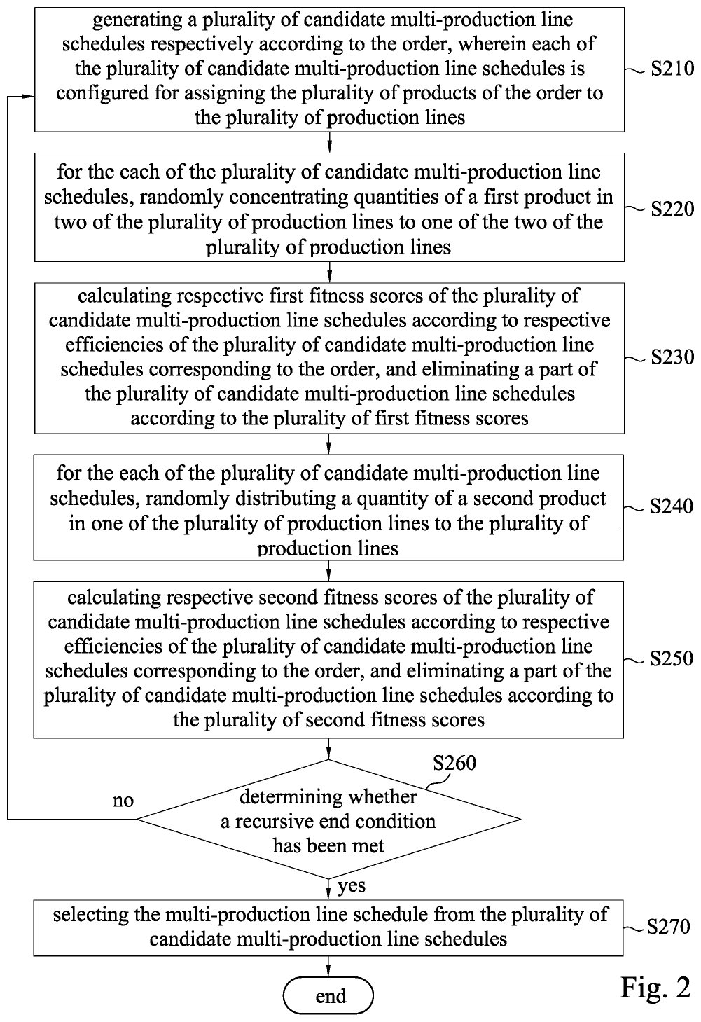

Reference is made to FIG. 2, which is a flowchart of a scheduling method of the present disclosure. The scheduling device 100 shown in FIG. 1 can be used to execute the scheduling method shown in FIG. 2.

As shown in FIG. 2, in step S210, generating multiple candidate multi-production line schedules respectively according to the order, where each of the multiple candidate multi-production line schedules is configured for assigning the multiple products of the order to the multiple production lines.

In some embodiments, the multiple products of the order can be distributed to the multiple production lines according to the production line information, and a quantity to be produced can be set for the products produced by each of the multiple production lines.

In step S220, for the each of the multiple candidate multi-production line schedules, randomly concentrating quantities of a first product in two of the multiple production lines to one of the two of the multiple production lines. In detail, this step performs first crossover processing on the production lines of each of the multiple candidate multi-production line schedules.

In some embodiments, for the each of the multiple candidate multi-production line schedules, the two of the multiple production lines for producing the first product can be randomly selected. Then, for the each of the multiple candidate multi-production line schedules, the demand quantities of the first product on the two of the plurality of production lines can be concentrated to the one of the two of the multiple production lines, and another of the two of the multiple production lines can be stopped from producing the first product.

In step S230, calculating respective first fitness scores of the multiple candidate multi-production line schedules according to respective efficiencies of the multiple candidate multi-production line schedules corresponding to the order, and eliminating a part of the multiple candidate multi-production line schedules according to the multiple first fitness scores.

In some embodiments, the respective efficiencies of the multiple candidate multi-production line schedules corresponding to the order are related to the order, the production line information, an changeover time table, an unit per second table, and a break table, where the changeover time table includes time required for the production line to change the product produced, the unit per second table includes a quantity of each product produced by all production lines per unit time, and the break table includes required suspension time for all production lines.

For example, the changeover time table is shown in the following Table 3, and the unit per second table is shown in the following Table 4.

TABLE 3

| | Product 1 | Product 2 | Product 3 | Product 4 |
|---|---|---|---|---|
| Product 1 | X | 10 seconds | 15 seconds | 7 seconds |
| Product 2 | 10 seconds | X | 5 seconds | 8 seconds |
| Product 3 | 15 seconds | 5 seconds | X | 9 seconds |
| Product 4 | 7 seconds | 8 seconds | 9 seconds | X |

TABLE4

| | Production | Production | Production |
|---|---|---|---|
| | line 1 | line 2 | line 3 |
| Product 1 | 0.833 | 0.167 | 0.100 |
| | (quantity)/second | (quantity)/second | (quantity)/second |
| Product 2 | 0.833 | 0.167 | 0.100 |
| | (quantity)/second | (quantity)/second | (quantity)/second |
| Product 3 | 0.100 | 0.200 | 0.050 |
| | (quantity)/second | (quantity)/second | (quantity)/second |
| Product 4 | 0.100 | 0.200 | 0.050 |
| | (quantity)/second | (quantity)/second | (quantity)/second |

It can be known from Table 3 that it takes 10 seconds for all production lines to be replaced between the production of product 1 and the production of product 2. It can be known from Table 4 that the production line 1 can produce 0.833 products 1 per second on average (i.e., it takes 12 seconds to produce 1 product 1).

In some embodiments, multiple weight values can be generated according to the candidate multi-production line schedule and multiple weight criteria, and the multiple weight values are used as the efficiency of the candidate multi-production line schedule corresponding to the order, so the first fitness score is generated according to the efficiency of the candidate multi-production line schedule corresponding to the order.

In some embodiments, a sum of the multiple weight values which correspond to the efficiency of the candidate multi-production line schedule corresponding to the order can be used as the first fitness score.

In some embodiments, the multiple weight criteria can include a weight per unit of the product underproduced by the candidate multi-production line schedule, a weight per unit of the product overproduced by the candidate multi-production line schedule, a weight per unit time of changeover time spent by the candidate multi-production line schedule, a weight of using one more production line to produce the same product in the candidate multi-production line schedule, a weight per unit time when production time of each production line in the candidate multi-production line schedule exceeds a time threshold, a weight per unit time of total production time of all production lines in the candidate multi-production line schedule, a weight whenever the quantity of the product produced by the production line is less than a quantity threshold in the candidate multi-production line schedule, and a weight per unit of the production line that produces the product in the candidate multi-production line schedule.

In detail, the weight per unit of the product underproduced by the candidate multi-production line schedule indicates a penalty weight (e.g. , with a weight of 1000) that is added by producing one less product when a certain product in the candidate multi-production line schedule cannot be produced to the demand quantity on the order. Furthermore, the weight per unit of the product overproduced by the candidate multi-production line schedule indicates a penalty weight (e.g., with a weight of 1000) that is added by producing one more product when a certain product in the candidate multi-production line schedule is produced over the demand quantity on the order. Furthermore, the weight per unit time of changeover time spent by the candidate multi-production line schedule indicates a penalty weight (e.g., with a weight of 0.001) to be increased by exchanging and producing one more product when a production line produces multiple products in the candidate multi-production line schedule.

Furthermore, the weight of using one more production line to produce the same product in the candidate multi-production line schedule indicates a penalty weight (e.g., with a weight of 100) to be added by using one more production line when a certain product in the candidate multi-production line schedule is produced on multiple production lines. Furthermore, the weight per unit time when production time of each production line in the candidate multi-production line schedule exceeds the time threshold indicates the penalty weight (e.g., with a weight of 0.01) to be added by spending more than one second when time that a production line in the candidate multi-production line schedule spends is more than the time threshold. Furthermore, the weight per unit time of the total production time of all production lines in the candidate multi-production line schedule indicates the penalty weight (e.g., with a weight of 0.001) to be added per unit time to the sum of the time spent for all production lines producing in the candidate multi-production line schedule.

Furthermore, the weight whenever the quantity of the product produced by the production line is less than the quantity threshold in the candidate multi-production line schedule indicates the penalty weight (e.g., a weight of 100) to be added per unit production line, which met a condition, when the condition that a quantity of a production line producing in the candidate multi-production line schedule is less than the quantity threshold happens. Furthermore, the weight per unit of the production line that produces the product in the candidate multi-production line schedule indicates the penalty weight (e.g., with a weight of 100) to be added per unit production line producing the product in the candidate multi-production line schedule.

In preferred embodiments, the multiple weight criteria can only include the weight per unit of the product underproduced by the candidate multi-production line schedule and the weight per unit of the product overproduced by the candidate multi-production line schedule.

It should be noted that a second fitness score and a third fitness score described below are also calculated in the same method as the first fitness score, so they will not be repeated in the following paragraphs.

In some embodiments, multiple production line schedules to be copied and multiple production line schedules to be deleted can be selected from the multiple candidate multi-production line schedules according to the multiple first fitness scores. Next, the multiple production line schedules to be copied among the multiple candidate multi-production line schedules can be copied, and the multiple production line schedules to be deleted among the multiple candidate multi-production line schedules are deleted, so the multiple candidate multi-production line schedules are updated. In some embodiments, the first fitness score of the production line schedule to be copied can be more than the first fitness score of the production line schedule to be deleted.

It should be noted that elimination according to the second fitness score and elimination according to the third fitness score described below are also in the same method, so they will not be repeated in the following paragraphs.

In step S240, for the each of the multiple candidate multi-production line schedules, randomly distributing a quantity of a second product in one of the multiple production lines to the multiple production lines. In other words, this step performs second crossover processing on the production lines of each of the multiple candidate multi-line schedules.

In some embodiments, for the each of the multiple candidate multi-production line schedules, ones of the multiple production lines with a largest total quantity are selected, and a production line to be distributed from the ones of the multiple production lines with the largest total quantity is randomly selected. Next, for the each of the multiple candidate multi-production line schedules, the second product with a largest quantity in the production line to be distributed to one of the plurality of production lines producing the second product is randomly distributed.

In step 250, calculating respective second fitness scores of the multiple candidate multi-production line schedules according to respective efficiencies of the multiple candidate multi-production line schedules corresponding to the order, and eliminating a part of the multiple candidate multi-production line schedules according to the multiple second fitness scores.

In step S260, determining whether a recursive end condition (i.e., this recursion has ended) has been met. If not, enter step S220 (i.e., start next recursion). If yes, enter step S270.

In some embodiments, whether the recursive end condition has been met can be determined according to the multiple second fitness scores. In some embodiments, a highest score among the multiple second fitness scores can be selected after each recursion, and it is determined whether the highest score among the multiple second fitness scores has not decreased in X times of recursion, where X can be a positive integer preset by an user (e.g., X is set to 20).

Next, when it is determined that the highest score among the multiple second fitness scores has not decreased in the X times of recursion, enter step S270. On the contrary, it can be determined whether a number of recursion is equal to a recursion threshold (e.g., 350 times). Next, when it is determined whether a number of recursion is equal to the recursion threshold, enter step S270. Otherwise, the recursion can continue (i.e., go back to step S220).

In step S270, selecting the multi-production line schedule from the multiple candidate multi-production line schedules. In some embodiments, the candidate multi-production line schedule with a highest score can be the multi-production line schedule in the recursion with the highest score.

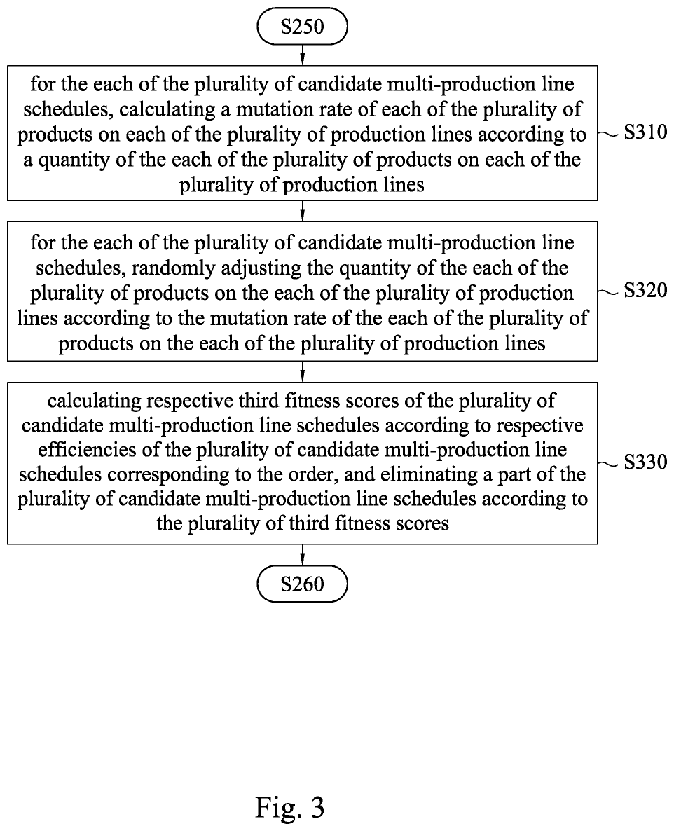

In alternative embodiments, reference is made to FIG. 3, which is a flowchart of additional steps of the scheduling method in some embodiments according to the present disclosure. After step S250 is performed, mutation processing in steps S310 to S330 can be further performed.

First, in step S310, for the each of the multiple candidate multi-production line schedules, calculating a mutation rate of each of the multiple products on each of the multiple production lines according to a quantity of each of the multiple products on each of the multiple production lines.

In some embodiments, for the each of the multiple candidate multi-production line schedules, a difference between a sum of the quantities of the multiple products on the multiple production lines and a demand quantity of the each of the multiple products on the multiple production lines can be calculated, and a difference between the quantity of the each of the multiple products on the each of the multiple production lines and a demand quantity of the each of the multiple products on the each of the multiple production lines can be calculated. Next, the mutation rate of each of the multiple products on the each of the multiple production lines can be calculated from the two differences.

In step S320, for the each of the multiple candidate multi-production line schedules, randomly adjusting the quantity of each of the multiple products on the each of the multiple production lines according to the mutation rate of the each of the multiple products on the each of the multiple production lines.

In some embodiments, a random number can be randomly selected from a numerical interval, and the quantity of the each of the multiple products on the each of the multiple production lines can be adjusted according to the random number. In some embodiments, when a highest score among the multiple third fitness scores in two consecutive recursions does not decrease, a upper limit value and a lower limit value of the numerical interval can be adjusted.

In step S330, calculating respective third fitness scores of the multiple candidate multi-production line schedules according to respective efficiencies of the multiple candidate multi-production line schedules corresponding to the order, and eliminating a part of the multiple candidate multi-production line schedules according to the multiple third fitness scores.

In this embodiment, after step S330 is performed, enter step S260.

In some embodiments, whether the recursive end condition has been met can be determined according to the multiple third fitness scores. In some embodiments, the highest score among the multiple third fitness scores can be selected after each recursion, and whether the highest score among the multiple third fitness scores has not decreased in X times of the recursions can be determined.

Next, when it is determined that the highest score among the multiple third fitness scores has not decreased in X times of the recursions, enter step S270. On the contrary, it can be determined whether the number of recursion is equal to the recursion threshold. Next, when it is determined whether the number of recursion is equal to the recursion threshold, enter step S270. Otherwise, the recursion can continue (i.e., go back to step S220).

With the above steps, the quantity of the certain product of two production lines in the candidate multi-production line schedule cab be concentrated to one of the two production lines in the first crossover processing, and in the second crossover processing, the products on over-concentrated production line are distributed to other production lines, so the quantities of the products in the production lines are mutated. In addition, the multiple weight criteria are used to filter the schedules. In this way, the products on the production lines can be prevented from being excessively distributed and concentrated, and the production lines can meet the multiple weight criteria to obtain the best scheduling result.

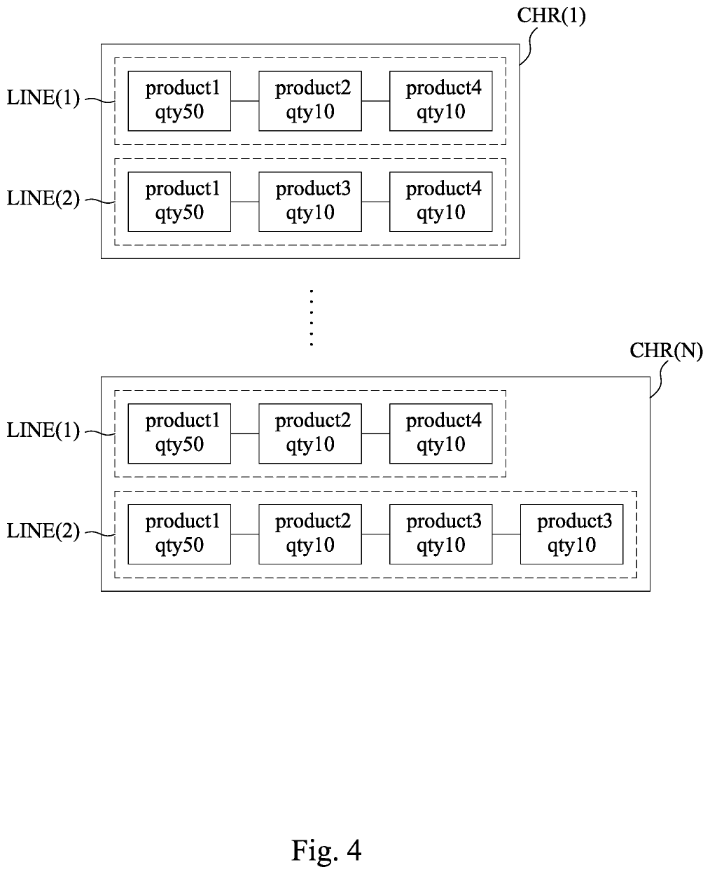

The above steps are explained below with practical examples. Reference is made to FIG. 4, which is a schematic diagram of the multiple candidate multi-production line schedules CHR (1) to CHR (N) in some embodiments according to the present disclosure.

As shown in FIG. 4, products 1 to 4 can be assigned to the candidate multi-production line schedules CHR (1) to CHR (N) in advance according to the order, where N can be any positive integer. Preferably, N can be 6. For the convenience of description, the candidate multi-production line schedule CHR (1) is used as an example below.

Further, assuming that there are currently production lines LINE (1) and LINE (2), the order has indicated 100 products to be produced for product 1, 10 products to be produced for product 2, 10 products to be produced for product 3, and 20 products to be produced for product 4, and the production line information has indicated that the production line LINE (1) can produce the products 1 to 2 and 4 and the production line LINE (2) can produce the products 1 and 3 to 4. In this way, in the initialization phase, the demand quantity of the products 1 and 4 can be distributed evenly to the production lines LINE (1) and LINE (2), the product 2 is assigned to be produced by the production line LINE (1), and the product 3 is assigned to be produced by the production line LINE (2).

Furthermore, the first fitness processing can be started on the candidate multi-production line schedule CHR (1). Further, one of the production lines LINE (1) and LINE (2) can be randomly selected, and one of the products can be randomly selected from the selected production line. Assuming that the product 4 in the production line LINE (1) is selected, one of the production lines LINE (1) and LINE (2) can be further randomly selected, and the quantity of the product 4 can be concentrated on the selected production line. Assuming that the production line LINE (1) is selected, the quantity of the product 4 can be concentrated on the production line LINE (1).

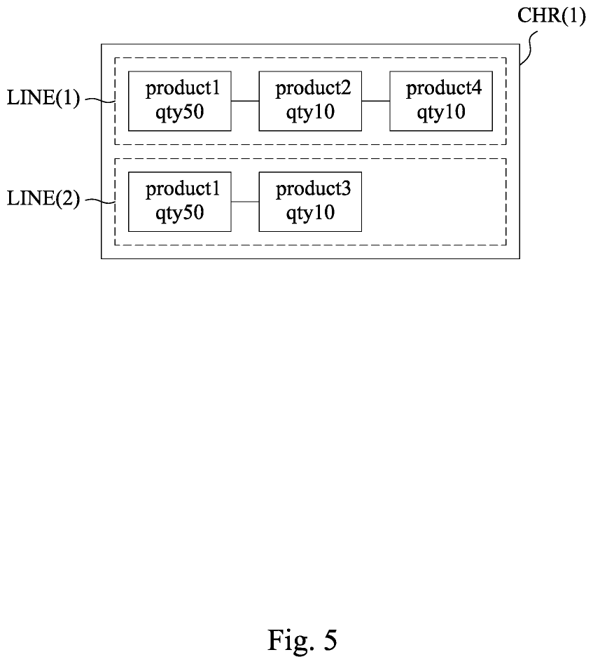

Reference is made to FIG. 5, which is a schematic diagram of concentrated processing of one of the multiple candidate multi-production line schedules in some embodiments according to the present disclosure. In the candidate multi-production line schedule CHR (1), the quantity of product 4 has been concentrated on the production line LINE (1). In this way, the production line LINE (1) can produce 40 products for the product 4.

Next, multiple weight values of the production line LINE (1) can be calculated according to the above-mentioned weight criteria. In detail, as far as the current candidate multi-production line schedule CHR (1) is concerned, there is no quantity that is larger or smaller than the demand quantity of the order. Therefore, a weight value per unit of the product underproduced by the candidate multi-production line schedule and a weight value per unit of the product overproduced by the candidate multi-production line schedule are both 0.

Furthermore, according to the above Table 3, it can be calculated that total time-consuming for changeover is 18 seconds, so a weight value per unit time of changeover time spent by the candidate multi-production line schedule can be calculated as 0.018 based on the above example. Furthermore, products 1 and 2 can be produced in two production lines, so a weight value of using one more production line to produce the same product in the candidate multi-production line schedule can be calculated as 200 based on the above example.

Furthermore, assuming that the break time of the production line LINE (1) is 100 seconds, the break time of the production line LINE (2) is 200 seconds, and the time threshold is 2000 seconds, that the production time of the production line LINE (1) is 1238 seconds and the production time of the production line LINE (2) is 865 seconds can be calculated according to Table 3 and Table 4 above. Therefore, that the production time of production lines LINE (1) and LINE (2) is not more than 2000 seconds can be determined, and a weight value per unit time when the production time of each production line in the candidate multi-production line schedule exceeds the time threshold is 0.

Furthermore, that total production time of the production lines LINE (1) and LINE (2) is 2865 can be calculated. Therefore, a weight value per unit time of total production time of all production lines in the candidate multi-production line schedule can be calculated as 2.865 based on the above example. Furthermore, assuming that the quantity threshold is 10, the quantities of the products on both production lines LINE (1) and LINE (2) are all more than 10. Therefore, a weight value whenever the quantity of the product produced by the production line is less than the quantity threshold in the candidate multi-production line schedule is 0.

Furthermore, the two production lines are currently used, so a weight value per unit of the production line that produces the product in the candidate multi-production line schedule can be calculated as 200 based on the above example. In this way, a total weight value of the candidate multi-production line schedule CHR (1) can be calculated as 402.883 as the first fitness score. Thereby, other candidate multi-production line schedules can be calculated in the same way to further eliminate several candidate multi-production line schedules.

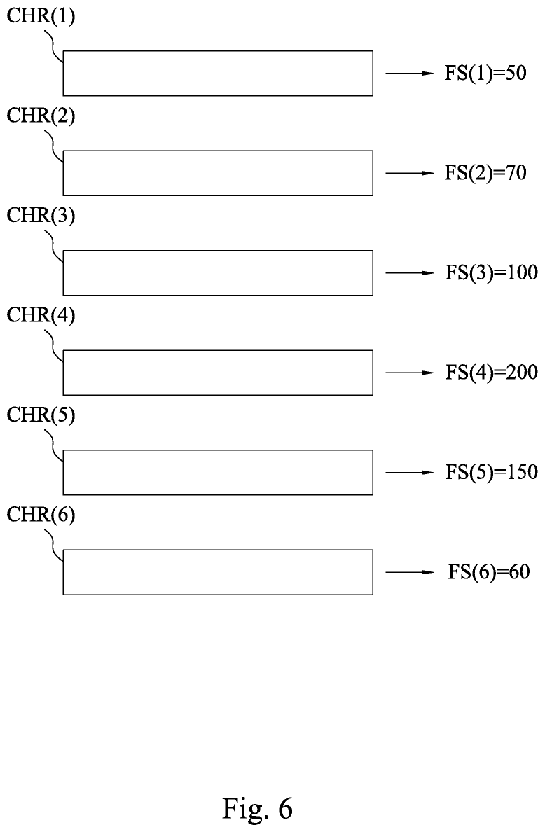

The above-mentioned elimination processing is described below by taking the existing candidate multi-production line schedules CHR (1) to CHR (6) as examples. Reference is made to FIG. 6, which is a schematic diagram of calculating fitness scores for the six candidate multi-production line schedules CHR (1) to CHR (6) in some embodiments according to the present disclosure.

As shown in FIG. 6, it assumes that the first fitness scores FS (1) to FS (6) of the candidate multi-production line schedules CHR (1) to CHR (6) are calculated in the same way as above to be 50, 70, 100, 200, 150 and 60, respectively.

Assuming that half of the candidate multi-production line schedules are to be eliminated, top three with highest scores (i.e., candidate multi-production line schedules CHR (3) to CHR (5)) can be selected according to the first fitness scores FS(1) to FS(6). Next, the candidate multi-production line schedules CHR (1) to CHR (2) and CHR (6) can be deleted.

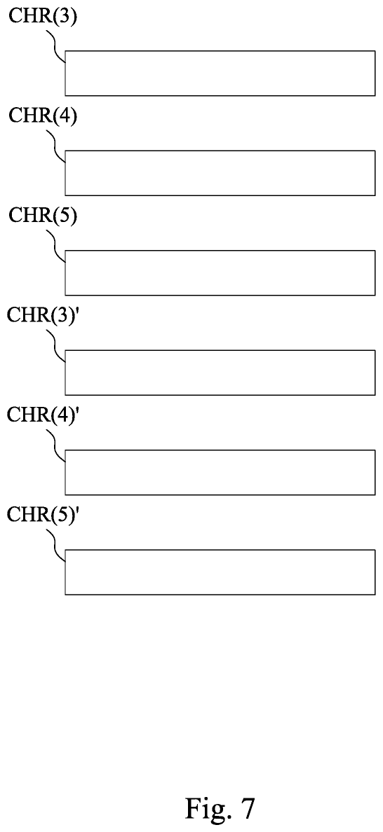

Reference is made to FIG. 7, which is a flow diagram of updating the six multi-production line schedules CHR (1) to CHR (6) in some embodiments according to the present disclosure. In this embodiment, the candidate multi-production line schedules CHR (3) to CHR (5) can be copied to generate candidate multi-production line schedules CHR (3)′ to CHR (5)′. In this way, the candidate multi-production line schedules CHR (3) to CHR (5) and CHR (3)′ to CHR (5)′ are the updated candidate multi-production line schedules.

The calculation of the second fitness scores and the third fitness scores and the elimination processing described later are performed in the same way, so they will not be described further.

As shown in FIG. 5, second crossover processing can continue to be performed on the candidate multi-production line schedule CHR (1). In detail, from the candidate multi-production line schedule CHR (1), Y production lines with the largest total quantities of the products to be produced can be selected, where Y can be any positive integer. Preferably, Y can be 2 or 3.

Assuming that Y is set to 2, from the candidate multi-production line schedule CHR (1), 2 production lines (i.e., the production lines LINE (1) and LINE (2)) with the largest total quantity of the products to be produced can be selected. Next, one of the production lines LINE (1) and LINE (2) as the production lines to be distributed can randomly be selected.

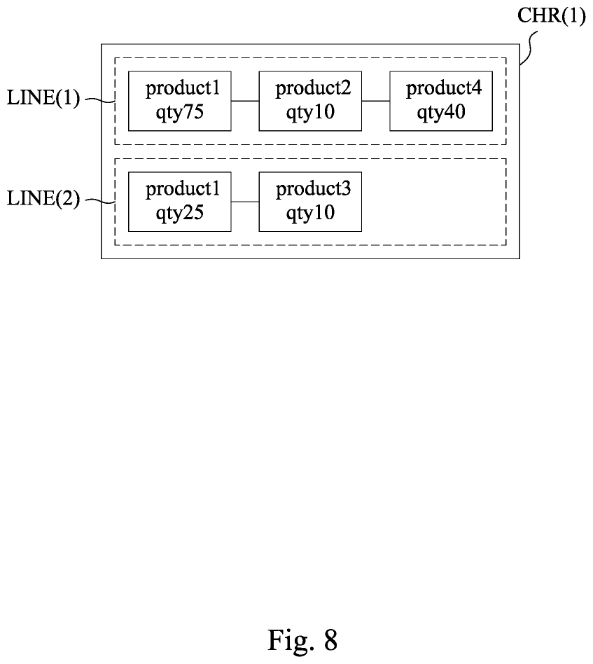

Reference is made to FIG. 8, which is a schematic diagram of the distributed processing of one of the multiple candidate multi-production line schedules CHR (1) to CHR (6) in some embodiments according to the present disclosure. As shown in FIG. 8, the production line LINE (1) has distributed half (i.e., 25) of the quantity for the product 1 to the production line LINE (2). At this time, the quantity for the product 1 in the production line LINE (2) is increased from 50 to 75. Next, the second fitness score is calculated by the above-mentioned method for calculating the first fitness score, and the candidate multi-production line schedule CHR (1) is updated by the above-mentioned method of the elimination processing according to the second fitness score.

Furthermore, the candidate multi-production line schedule CHR (1) can be mutated. In detail, a respective mutation rate can be calculated separately for each of the products on the production lines LINE (1) and LINE (2) in the candidate multi-production line schedule CHR (1). For example, the mutation rate for the product 1 on the production line LINE (1) is shown in Equation 1 below.

Mutation rate=(the quantity for the product 1 on the production line LINE (1)−the demand quantity for the product 1 on the order)\hat{ }2/(max (a sum of the quantities for each products on all production lines−the demand quantity for the each product on the order))\hat{ }2 Equation 1

Where max(,) is a maximum value function. By analogy, the mutation rate for the products 2 and 4 on the production line LINE (1) and the mutation rate for the products 1 and 3 of production line LINE (2) can be calculated by similar equations. Assuming the difference between the sum of the quantities for the one product on the candidate multi-production line schedule CHR (1) and the demand quantity for this product on the order is −90, this difference is the largest among the differences corresponding to all products, and the difference between the quantity for the product 1 on the production line LINE (1) and the demand quantity for the product 1 on the order is −25. At this time, the mutation rate for the product 1 on the production line LINE (1) has a denominator of 8100 and a numerator of 625. Next, a random number is randomly obtained from a numerical interval more than or equal to 0 and less than 1. When the random number is less than the mutation rate, the mutation processing can be performed on product 1 on the production line LINE (1). Otherwise, the quantity for the product 1 on the production line LINE (1) is maintained.

Assuming that the mutation processing is currently performed on the product 1 on the production line LINE (1), since the difference between the quantity for the product 1 on the production line LINE (1) and the demand quantity for the product 1 on the order is negative, a positive integer can be randomly selected from 64 to 128 to add the quantity for product 1 on the production line LINE (1).

It should be noted that, assuming that the difference between the quantity for the product 1 on the production line LINE(1) and the demand quantity for the product 1 on the order is positive, a positive integer can be randomly selected from 64 to 128 to substrate the quantity for the product 1 on the production line LINE (1) (If the random number is more than the quantity for the product 1 on the production line LINE (1), the quantity for the product 1 on the production line LINE (1) is maintained).

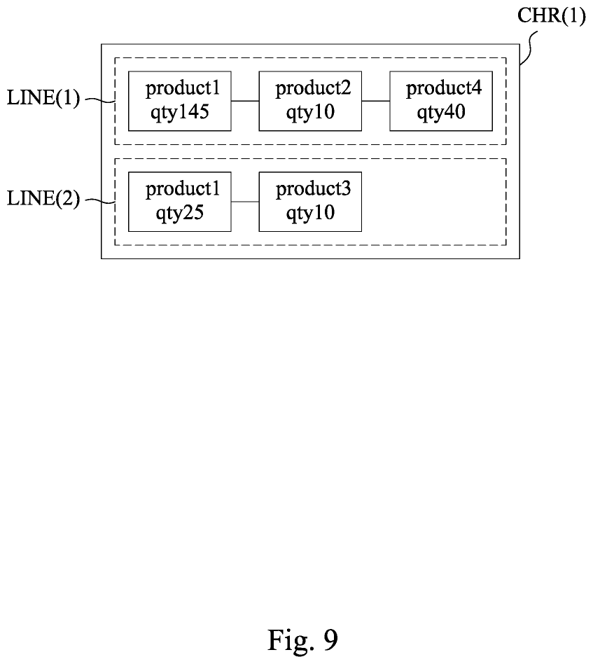

Reference is made to FIG. 9, which is a schematic diagram of the mutation processing of one of the multiple candidate multi-production line schedules CHR (1) to CHR (6) in some embodiments according to the present disclosure. As shown in FIG. 9, the currently selected random number is 70, so the quantity for the product 1 on the production line LINE (1) is increased from 75 to 145. Next, the third fitness score is calculated by the above-mentioned method for calculating the first fitness score, and the candidate multi-production line schedule CHR(1) is updated by the above-mentioned method of the elimination processing according to the third fitness score.

It should be noted that as the number of recursions increases, when the highest score among the multiple third fitness scores in two consecutive recursions does not decrease, the above-mentioned numerical interval of 64 to 128 can be adjusted to a numerical interval of 32 to 64. By analogy, whenever the highest score among the multiple third fitness scores in two consecutive recursions does not decrease, the upper limit and the lower limit of the numerical interval of the random number are divided by 2, and the numerical interval will not be adjusted until the numerical interval of the random number is 1 to 2.

In summary, the scheduling device provided by the present disclosure performs the concentrated processing and the distributed processing on the quantities of the products on a production line in the multiple candidate multi-production line schedules. In this way, the multiple candidate multi-production line schedules can be continuously updated and eliminated to generate an optimal production line schedule, so as to effectively solve the problem of poor traditional scheduling effect. In addition, these quantities can be randomly mutated to increase the efficiency of recursive convergence.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A scheduling device, configured for generating a multi-production line schedule to produce an order, wherein the order comprises a plurality of products and a plurality of demand quantities of the plurality of products, and the multi-production line is configured for scheduling a sequence and quantities of the plurality of products to be produced by a plurality of production lines, wherein the scheduling device comprises:
a memory, configured for storing a plurality of instructions; and
a processor, connected to the memory, and configured for executing the plurality of instructions to perform the following operations:
(a) generating a plurality of candidate multi-production line schedules respectively according to the order, wherein each of the plurality of candidate multi-production line schedules is configured for assigning the plurality of products of the order to the plurality of production lines;
(b) for the each of the plurality of candidate multi-production line schedules, randomly concentrating quantities of a first product on two of the plurality of production lines to one of the two of the plurality of production lines;
(c) calculating respective first fitness scores of the plurality of candidate multi-production line schedules according to respective efficiencies of the plurality of candidate multi-production line schedules corresponding to the order, and eliminating a part of the plurality of candidate multi-production line schedules according to the plurality of first fitness scores;
(d) for the each of the plurality of candidate multi-production line schedules, randomly distributing a quantity of a second product on one of the plurality of production lines to the plurality of production lines;
(e) calculating respective second fitness scores of the plurality of candidate multi-production line schedules according to respective efficiencies of the plurality of candidate multi-production line schedules corresponding to the order, and eliminating a part of the plurality of candidate multi-production line schedules according to the plurality of second fitness scores;
(f) determining whether a recursive end condition has been met according to the plurality of second fitness scores;
(g) selecting the multi-production line schedule from the plurality of candidate multi-production line schedules when the recursive end condition has been met; and
(h) performing steps (b) to (f) again when the recursive end condition has not been met.

2. The scheduling device of claim 1, wherein the step (b) performed by the processor comprises:
(b1) for the each of the plurality of candidate multi-production line schedules, randomly selecting the two of the plurality of production lines for producing the first product; and
(b2) for the each of the plurality of candidate multi-production line schedules, concentrating the demand quantities of the first product on the two of the plurality of production lines to the one of the two of the plurality of production lines, and stopping another of the two of the plurality of production lines from producing the first product.

3. The scheduling device of claim 1, wherein the memory is further configured for storing a plurality of weight criteria, and the step (c) performed by the processor comprises:
(c1) for the each of the plurality of candidate multi-production line schedules, generating a plurality of weight values according to the each of the plurality of candidate multi-production line schedules and the plurality of weight criteria; and
(c2) setting the plurality of weight values as the efficiency of the each of the plurality of candidate multi-production line schedules corresponding to the order, so as to generating the first fitness score of the each of the plurality of candidate multi-production line schedules according to the efficiency of the each of the plurality of candidate multi-production line schedules corresponding to the order.

4. The scheduling device of claim 3, wherein the step (c2) performed by the processor comprises:
setting a sum of the plurality of weight values which correspond to the efficiency of the each of the plurality of candidate multi-production line schedules corresponding to the order as the first fitness score of the each of the plurality of candidate multi-production line schedules.

5. The scheduling device of claim 1, wherein the step (c) performed by the processor comprises:
(c3) selecting a plurality of production line schedules to be copied and a plurality of production line schedules to be deleted from the plurality of candidate multi-production line schedules according to the plurality of first fitness scores; and
(c4) copying the plurality of production line schedules to be copied among the plurality of candidate multi-production line schedules, and deleting the plurality of production line schedules to be deleted among the plurality of candidate multi-production line schedules, so as to update the plurality of candidate multi-production line schedules.

6. The scheduling device of claim 5, wherein the first fitness score of the production line schedule to be copied is more than the first fitness score of the production line schedule to be deleted.

7. The scheduling device of claim 1, wherein the step (d) performed by the processor comprises:
(d1) for the each of the plurality of candidate multi-production line schedules, selecting ones of the plurality of production lines with a largest total quantity, and randomly selecting a production line to be distributed from the ones of the plurality of production lines with the largest total quantity; and
(d2) for the each of the plurality of candidate multi-production line schedules, randomly distributing the second product with a largest quantity in the production line to be distributed to one of the plurality of production lines producing the second product.

8. The scheduling device of claim 1, wherein the steps performed by the processor further comprises:
for the each of the plurality of candidate multi-production line schedules, calculating a mutation rate of each of the plurality of products on each of the plurality of production lines according to a quantity of each of the plurality of products on each of the plurality of production lines;
for the each of the plurality of candidate multi-production line schedules, randomly adjusting the quantity of each of the plurality of products on the each of the plurality of production lines according to the mutation rate of the each of the plurality of products on the each of the plurality of production lines; and
calculating respective third fitness scores of the plurality of candidate multi-production line schedules according to respective efficiencies of the plurality of candidate multi-production line schedules corresponding to the order, and eliminating a part of the plurality of candidate multi-production line schedules according to the plurality of third fitness scores.

9. The scheduling device of claim 8, wherein the steps performed by the processor further comprises:
determining whether the recursive end condition has been met according to the plurality of third fitness scores.

10. The scheduling device of claim 1, wherein the respective efficiencies of the plurality of candidate multi-production line schedules corresponding to the order are related to the order, production line information, an changeover time table, an unit per second table, and a break table.

11. A scheduling method, configured for generating a multi-production line schedule to produce an order, wherein the order comprises a plurality of products and a plurality of demand quantities of the plurality of products, and the multi-production line is configured for scheduling a sequence and quantities of the plurality of products to be produced by a plurality of production lines, wherein the scheduling method comprises:
(a) generating a plurality of candidate multi-production line schedules respectively according to the order, wherein each of the plurality of candidate multi-production line schedules is configured for assigning the plurality of products of the order to the plurality of production lines;
(b) for the each of the plurality of candidate multi-production line schedules, randomly concentrating quantities of a first product on two of the plurality of production lines to one of the two of the plurality of production lines;
(c) calculating respective first fitness scores of the plurality of candidate multi-production line schedules according to respective efficiencies of the plurality of candidate multi-production line schedules corresponding to the order, and eliminating a part of the plurality of candidate multi-production line schedules according to the plurality of first fitness scores;
(d) for the each of the plurality of candidate multi-production line schedules, randomly distributing a quantity of a second product on one of the plurality of production lines to the plurality of production lines;
(e) calculating respective second fitness scores of the plurality of candidate multi-production line schedules according to respective efficiencies of the plurality of candidate multi-production line schedules corresponding to the order, and eliminating a part of the plurality of candidate multi-production line schedules according to the plurality of second fitness scores;
(f) determining whether a recursive end condition has been met according to the plurality of second fitness scores;
(g) selecting the multi-production line schedule from the plurality of candidate multi-production line schedules when the recursive end condition has been met; and
(h) performing steps (b) to (f) again when the recursive end condition has not been met.

12. The scheduling method of claim 11, wherein the step (b) comprises:
(b1) for the each of the plurality of candidate multi-production line schedules, randomly selecting the two of the plurality of production lines for producing the first product; and
(b2) for the each of the plurality of candidate multi-production line schedules, concentrating the demand quantities of the first product on the two of the plurality of production lines to the one of the two of the plurality of production lines, and stopping another of the two of the plurality of production lines from producing the first product.

13. The scheduling method of claim 11, wherein the step (c) comprises:
(c1) for the each of the plurality of candidate multi-production line schedules, generating a plurality of weight values according to the each of the plurality of candidate multi-production line schedules and a plurality of weight criteria; and
(c2) setting the plurality of weight values as the efficiency of the each of the plurality of candidate multi-production line schedules corresponding to the order, so as to generating the first fitness score of the each of the plurality of candidate multi-production line schedules according to the efficiency of the each of the plurality of candidate multi-production line schedules corresponding to the order.

14. The scheduling method of claim 13, wherein the step (c2) comprises:
setting a sum of the plurality of weight values which correspond to the efficiency of the each of the plurality of candidate multi-production line schedules corresponding to the order as the first fitness score of the each of the plurality of candidate multi-production line schedules.

15. The scheduling method of claim 11, wherein the step (c) comprises:
(c3) selecting a plurality of production line schedules to be copied and a plurality of production line schedules to be deleted from the plurality of candidate multi-production line schedules according to the plurality of first fitness scores; and
(c4) copying the plurality of production line schedules to be copied among the plurality of candidate multi-production line schedules, and deleting the plurality of production line schedules to be deleted among the plurality of candidate multi-production line schedules, so as to update the plurality of candidate multi-production line schedules.

16. The scheduling method of claim 15, wherein the first fitness score of the production line schedule to be copied is more than the first fitness score of the production line schedule to be deleted.

17. The scheduling method of claim 11, wherein the step (d) comprises:
(d1) for the each of the plurality of candidate multi-production line schedules, selecting ones of the plurality of production lines with a largest total quantity, and randomly selecting a production line to be distributed from the ones of the plurality of production lines with the largest total quantity; and
(d2) for the each of the plurality of candidate multi-production line schedules, randomly distributing the second product with a largest quantity in the production line to be distributed to one of the plurality of production lines producing the second product.

18. The scheduling method of claim 11, further comprising:
for the each of the plurality of candidate multi-production line schedules, calculating a mutation rate of each of the plurality of products on each of the plurality of production lines according to a quantity of each of the plurality of products on each of the plurality of production lines;
for the each of the plurality of candidate multi-production line schedules, randomly adjusting the quantity of each of the plurality of products on the each of the plurality of production lines according to the mutation rate of the each of the plurality of products on the each of the plurality of production lines; and
calculating respective third fitness scores of the plurality of candidate multi-production line schedules according to respective efficiencies of the plurality of candidate multi-production line schedules corresponding to the order, and eliminating a part of the plurality of candidate multi-production line schedules according to the plurality of third fitness scores.

19. The scheduling method of claim 18, further comprises:
determining whether the recursive end condition has been met according to the plurality of third fitness scores.

20. The scheduling method of claim 11, wherein the respective efficiencies of the plurality of candidate multi-production line schedules corresponding to the order are related to the order, production line information, an changeover time table, an unit per second table, and a break table.
